(19) United States
(12) Patent Application Publication
(10) Pub. No.: US 2026/0221062 A1
(43) Pub. Date: Jul. 30, 2026

(54) DISPLAY DEVICE AND POWER CONSUMPTION REDUCTION METHOD THEREOF

(71) Applicant: LG ELECTRONICS INC., Seoul (KR)

(72) Inventor: Kyung Min KIM, Seoul (KR)

(73) Assignee: LG ELECTRONICS INC., Seoul (KR)

(21) Appl. No.: 19/148,831

(22) PCT Filed: Jan. 18, 2023
(86) PCT No.: PCT/KR2023/000853

§ 371 Date: Jul. 17, 2025

(51) Int. Cl. G09G 3/00; G09G 3/20

(52) U.S. Cl. CPC G09G 3/006; G09G 3/2096; G09G 2330/021; G09G 2354/00

(57) ABSTRACT

The present disclosure relates to a display device and a power consumption reduction method thereof, in which power consumption may be reduced by varying a voltage according to an output current of a display screen, wherein the display device may: determine, on the basis of a value of an output current sensed by a sensing unit, whether to change an output voltage applied to a display module; when it is determined to change the output voltage, control a voltage change unit to change the output voltage; count the number of times of change control of the output voltage; and on the basis of the counted number of times of change control, control a compensation unit to compensate for the loss of the sensing unit by delaying sensing of the output current.

### TECHNICAL FIELD

The present disclosure relates to a display device capable of reducing power consumption by varying voltage according to the output current of a display screen, and a method for reducing power consumption thereof.

### BACKGROUND ART

In general, a display device is a device that has the function of receiving, processing, and displaying images that can be viewed by a user. A display device receives a broadcast signal selected by a user from among broadcast signals transmitted from a broadcasting station, separates an image signal from the received signal, and then displays the separated image signal on a display.

In recent years, due to the development of broadcasting technology and network technology, the functions of display devices have diversified considerably, and the performance of the devices has also improved accordingly. In other words, display devices have evolved to provide users with not only broadcast content but also various other content.

For example, the display device can provide not only programs received from broadcasting stations, but also game play, music appreciation, Internet shopping, and customized information using various applications. In order to perform these expanded functions, the display device is basically connected to other devices or networks using various communication protocols, and can provide a ubiquitous computing environment to the user. In other words, the display device has evolved into a smart device that enables connectivity to a network and ubiquitous computing.

Meanwhile, the display device can provide various screen modes such as echo image and clear image.

However, the display device may consume more power because it requires a high output voltage in screen modes that require bright images, such as clear images.

For example, for OLED displays, in eco mode, an output voltage of about 20 V is required, but in vivid mode, an output voltage of about 22 V is required, so it requires more power than in eco mode.

In this way, there was a problem that power consumption was not reduced because the display device only provided voltage at the output voltage set corresponding to the screen mode.

Therefore, in the future, it is necessary to develop a display device that can reduce power consumption in screen modes that require high output voltage, such as clear screen mode.

### DISCLOSURE

### Technical Problem

An object of the present disclosure is to solve the problems described above and other problems.

An object of the present disclosure is to provide a display device which can reduce power consumption of a video screen regardless of an image mode by sensing an output current of a voltage output terminal to increase or decrease the output voltage, thereby increasing the output voltage to provide a bright screen when the output current is large and reducing the output voltage to provide a dark screen when the output current is small, and a method for reducing power consumption thereof.

In addition, an object of the present disclosure is to provide a display device which can minimize current loss in a circuit that senses output current by counting the number of times the output voltage is controlled to be changed and delaying sensing of the output current, and a method for reducing power consumption thereof.

### Technical Solution

According to an embodiment of the present disclosure, a display device includes a sensing part sensing an output current supplied to a display module; a voltage changing part changing an output voltage supplied to the display module; a compensation part compensating for a loss of the sensing part due to a change in the output voltage; and, a control part controlling the voltage changing part and the compensation part, in which the control part may determine whether to change the output voltage supplied to the display module based on the output current value sensed by the sensing part, and control the voltage changing part to change the output voltage if the change in the output voltage is determined, count the number of times the output voltage is controlled to be change, and control the compensation part to compensate for the loss of the sensing part by delaying the sensing of the output current based on the counted number of times the change is controlled.

According to an embodiment of the present disclosure, a method for reducing power consumption of a display device may include sensing an output current of a voltage output terminal supplied to the display module; changing an output voltage supplied to the display module based on the output current; counting the number of times the output voltage is controlled to be changed; delaying the sensing of the output current based on the counted number of times the change is controlled; and releasing the sensing delay of the output current when the sensing delay time of the output current reaches a set time.

### Advantageous Effect

According to one embodiment of the present disclosure, the display device can reduce power consumption of a video screen regardless of the image mode by sensing an output current of a voltage output terminal to increase or decrease the output voltage, thereby increasing the output voltage to provide a bright screen when the output current is large and decreasing the output voltage to provide a dark screen when the output current is small.

In addition, the present disclosure can minimize current loss in a circuit that senses output current by delaying sensing of the output current by counting the number of times the output voltage is controlled to be changed.

In other words, the present disclosure can reduce the power consumption of a display device not only by reducing power consumption in a specific image mode such as an eco mode, but also by reducing voltage according to the current of a video screen regardless of all image modes.

### DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present disclosure.

FIG. 3 is a view illustrating an actual configuration of a remote control device according to an embodiment of the present disclosure.

FIG. 4 is a view illustrating an example of utilizing a remote control device according to an embodiment of the present disclosure.

FIG. 5 is a block diagram illustrating a display device for reducing power consumption according to one embodiment of the present disclosure.

FIG. 6 is a circuit diagram for explaining a process for reducing power consumption of a display device according to an embodiment of the present disclosure.

FIG. 7 is a waveform diagram for explaining an output current sensing process of a display device according to an embodiment of the present disclosure.

FIGS. 8 to 10 are block diagrams for explaining a determination of a change in output voltage of a display device according to an embodiment of the present disclosure.

FIGS. 11 to 13 are diagrams for explaining an output voltage change control process of a display device according to an embodiment of the present disclosure.

FIGS. 14 and 15 are flowcharts for explaining a process for reducing power consumption of a display device according to an embodiment of the present disclosure.

### BEST MODE

Hereinafter, embodiments disclosed in the present specification will be described in detail with reference to the attached drawings, and regardless of the drawing symbols, identical or similar components will be given the same reference numerals and redundant descriptions thereof will be omitted. The suffixes “module” and “part” for components used in the description below are assigned or mixed in consideration of easiness in writing the specification and do not have distinctive meanings or roles by themselves. In addition, when describing embodiments disclosed in this specification and if it is determined that a specific description of a related known technology may obscure the gist of the embodiments disclosed in this specification, the detailed description thereof will be omitted. In addition, the attached drawings are only intended to facilitate easy understanding of the embodiments disclosed in this specification, and the technical ideas disclosed in this specification are not limited by the attached drawings, and should be understood to include all modifications, equivalents, and substitutes included in the spirit and technical scope of the present disclosure.

Terms including ordinal numbers, such as first, second, or the like, may be used to describe various components, but the components are not limited by the terms. The terms are used only to distinguish one component from another.

When it is said that a component is “connected” or “accessed” to another component, it should be understood that it may be directly connected or accessed to that other component, but that there may be other components in between. On the other hand, when it is said that a component is “directly connected” or “directly accessed” to another component, it should be understood that there are no other components in between.

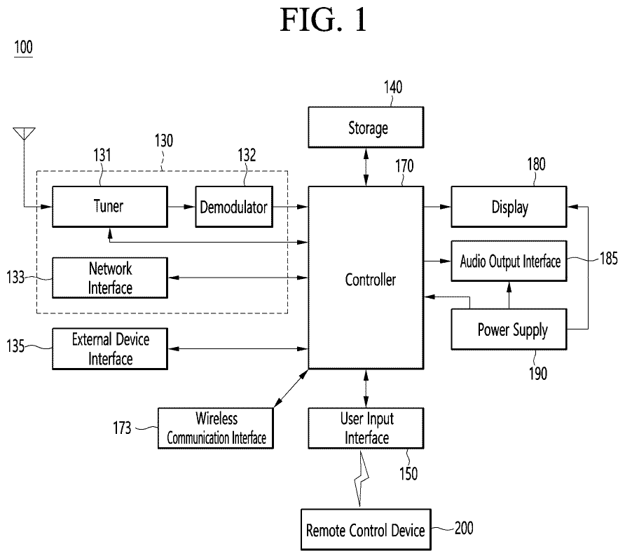

FIG. 1 is a block diagram illustrating a configuration of a display device according to an embodiment of the present disclosure.

[Referring to FIG. 1, a display device 100 may include a broadcast reception module 130, an external device interface part 135, a storage part 140, a user input part 150, a control part 170, a wireless communication interface part 173, a display part 180, an audio output part 185, and a power supply part 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulation part 132 may divide the received broadcast signals into video signals, audio signals, and broadcast program-related data signals, and may restore the divided video signals, audio signals, and data signals into an output available form.

The network interface 133 may provide an interface for connecting the display device 100 to a wired/wireless network comprising internet network. The network interface 133 may transmit or receive data to or from another user or another electronic device through an accessed network or another network linked to the accessed network.

The network interface part 133 may access a predetermined webpage through an accessed network or another network linked to the accessed network. In other words, the network interface part 133 may transmit or receive data to or from a corresponding server by accessing a predetermined webpage through the network.

The network interface part 133 may receive content or data provided from a content provider or a network operator. In other words, the network interface part 133 may receive content, such as movies, advertisements, games, VODs, and broadcast signals, which are provided from the content provider or the network operator, and information relating thereto through the network.

In addition, the network interface part 133 may receive firmware update information and update files provided from the network operator, and may transmit data to the Internet or content provider or the network operator.

The network interface 133 may select and receive a desired application among applications open to the air, through network.

The external device interface part 135 may receive an application or an application list in an adjacent external device and deliver the application or the application list to the control part 170 or the storage part 140.

The external device interface part 135 may provide a connection path between the display device 100 and an external device. The external device interface part 135 may receive at least one of an image or audio outputted from an external device that is wirelessly or wiredly connected to the display device 100 and deliver the received image or the audio to the controller. The external device interface part 135 may include a plurality of external input terminals. The plurality of external input terminals may include an RGB terminal, at least one High Definition Multimedia Interface (HDMI) terminal, and a component terminal.

An image signal of an external device inputted through the external device interface part 135 may be outputted through the display part 180. A sound signal of an external device inputted through the external device interface part 135 may be outputted through the audio output part 185.

An external device connectable to the external device interface part 135 may be one of a set-top box, a Blu-ray player, a DVD player, a game console, a sound bar, a smartphone, a PC, a USB Memory, and a home theater system but this is just exemplary.

Additionally, some content data stored in the display device 100 may be transmitted to a user or an electronic device, which is selected from other users or other electronic devices pre-registered in the display device 100.

The storage part 140 may store signal-processed image, voice, or data signals stored by a program in order for each signal processing and control in the control part 170.

In addition, the storage part 140 may perform a function for temporarily storing image, voice, or data signals output from the external device interface part 135 or the network interface part 133, and may store information on a predetermined image through a channel memory function.

The storage part 140 may store an application or an application list input from the external device interface part 135 or the network interface part 133.

The display device 100 may play content files (e.g., video files, still image files, music files, document files, application files, etc.) stored in the storage part 140, and may provide the content files to a user.

The user input part 150 may transmit signals input by a user to the control part 170, or may transmit signals from the control part 170 to a user. For example, the user input part 150 may receive or process control signals such as power on/off, channel selection, and screen setting from the remote control device 200 or transmit control signals from the control part 170 to the remote control device 200 according to various communication methods such as Bluetooth, Ultra Wideband (WB), ZigBee, Radio Frequency (RF), and IR communication methods.

In addition, the user input part 150 may transmit, to the control part 170, control signals input from local keys (not illustrated) such as a power key, a channel key, a volume key, and a setting key.

Image signals that are image-processed by the control part 170 may be input to the display part 180 and displayed as images corresponding to the image signals. In addition, image signals that are image-processed by the control part 170 may be input to an external output device through the external device interface part 135.

Voice signals processed by the control part 170 may be output to the audio output part 185. In addition, voice signals processed by the control part 170 may be input to the external output device through the external device interface part 135.

Additionally, the control part 170 may control overall operations of the display device 100.

In addition, the control part 170 may control the display device 100 by a user command or an internal program input through the user input part 150, and may access the network to download a desired application or application list into the display device 100.

The control part 170 may output channel information selected by a user together with the processed image or voice signals through the display part 180 or the audio output part 185.

In addition, the control part 170 may output image signals or voice signals of an external device such as a camera or a camcorder, which are input through the external device interface part 135, through the display part 180 or the audio output part 185, according to an external device image playback command received through the user input part 150.

Moreover, the control part 170 may control the display part 180 to display images, and may control the display part 180 to display broadcast images input through the tuner 131, external input images input through the external device interface part 135, images input through the network interface part, or images stored in the storage part 140. In this case, an image displayed on the display part 180 may be a still image or video and also may be a 2D image or a 3D image.

Additionally, the control part 170 may play content stored in the display device 100, received broadcast content, and external input content input from the outside, and the content may be in various formats such as broadcast images, external input images, audio files, still images, accessed web screens, and document files.

Moreover, the wireless communication part 173 may perform wired or wireless communication with an external device. The wireless communication part 173 may perform short-range communication with an external device. For this, the wireless communication part 173 may support short-range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication part 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication part 173 may detect (or recognize) a wearable device capable of communication around the display device 100. Furthermore, if the detected wearable device is a device authenticated to communicate with the display device 100, the control part 170 may transmit at least part of data processed in the display device 100 to the wearable device through the wireless communication part 173. Therefore, a user of the wearable device may use the data processed by the display device 100 through the wearable device.

The voice acquisition part 175 may acquire audio. The voice acquisition part 175 may include at least one microphone (not illustrated) and may acquire audio around the display device 100 through the microphone (not illustrated).

The display part 180 may convert image signals, data signals, or on-screen display (OSD) signals, which are processed in the control part 170, or images signals or data signals, which are received in the external device interface part 135, into R, G, and B signals to generate driving signals.

Furthermore, the display device 100 illustrated in FIG. 1 is just one embodiment of the present disclosure and thus, some of the components illustrated may be integrated, added, or omitted according to the specification of the actually implemented display device 100.

In other words, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface part 133 or the external device interface part 135 and play them without including the tuner 131 and the demodulation part 132.

For example, the display device 100 may be divided into an image processing device such as a set-top box for receiving broadcast signals or contents according to various network services and a content playback device for playing content input from the image processing device.

In this case, an operating method of a display device according to an embodiment of the present disclosure described below may be performed by one of the display device described with reference to FIG. 1, an image processing device such as the separated set-top box, and a content playback device including the display part 180 and the audio output part 185.

The audio output part 185 receives the audio-processed signal from the control part 170 to output an audio signal.

The power supply part 190 supplies the corresponding power to the entire display device 100. Particularly, power may be supplied to the control part 170 that is capable of being implemented in the form of a system on chip (SOC), the display part 180 for displaying an image, the audio output part 185 for outputting audio, and the like.

Specifically, the power supply part 190 may include a converter that converts AC power to DC power and a DC/DC converter that converts a level of the DC power.

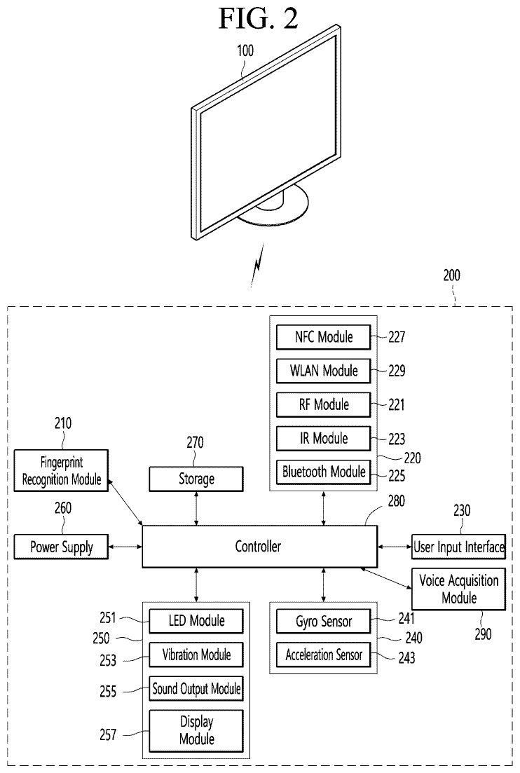

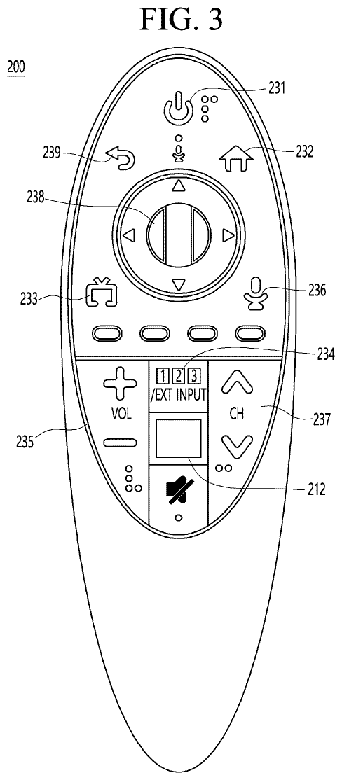

A remote control device according to an embodiment of the present disclosure will be described with reference to FIGS. 2 and 3.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 may include a fingerprint recognition part 210, a wireless communication part 220, a user input part 230, a sensor part 240, an output part 250, a power supply part 260, a storage part 270, a control part 280, and a sound acquisition part 290.

Referring to FIG. 2, the wireless communication part 220 transmits/receives signals to/from an arbitrary any one of display devices according to the above-mentioned embodiments of the present disclosure.

The remote control device 200 may include a radio frequency (RF) module 221 capable of transmitting or receiving signals to or from the display device 100 according to an RF communication standard, and an IR module 223 capable of transmitting or receiving signals to or from the display device 100 according to an IR communication standard. In addition, the remote control device 200 may include a Bluetooth module 225 capable of transmitting or receiving signals to or from the display device 100 according to a Bluetooth communication standard. In addition, the remote control device 200 may include an NFC module 227 capable of transmitting or receiving signals to or from the display device 100 according to an NFC communication standard, and a wireless LAN (WLAN) module 229 capable of transmitting or receiving signals to or from the display device 100 according to a WLAN communication standard.

In addition, the remote control device 200 may transmit signals containing information on the movement of the remote control device 200 to the display device 100 through the wireless communication part 220.

Moreover, the remote control device 200 may receive signals transmitted from the display device 100 through the RF module 221 and if necessary, may transmit a command for power on/off, channel change, and volume change to the display device 100 through the IR module 223.

The user input part 230 may be configured with a keypad, a button, a touch pad, or a touch screen. A user may operate the user input part 230 to input a command relating to the display device 100 to the remote control device 200. If the user input part 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation. The power button 231 may be a button for turning on/off the power of the display device 100. The home button 232 may be a button for moving to the home screen of the display device 100. The live button 233 may be a button for displaying live broadcast programs. The external input button 234 may be a button for receiving an external input connected to the display device 100. The volume control button 235 may be a button for controlling a volume output from the display device 100. The voice recognition button 236 may be a button for receiving user's voice and recognizing the received voice. The channel change button 237 may be a button for receiving broadcast signals of a specific broadcast channel. The OK button 238 may be a button for selecting a specific function, and the back button 239 may be a button for returning to a previous screen.

FIG. 2 is described again.

If the user input part 230 includes a touch screen, a user may touch a soft key of the touch screen to input a command relating to the display device 100 to the remote control device 200. In addition, the user input part 230 may include various kinds of input interfaces operable by a user, for example, a scroll key and a jog key, and this embodiment does not limit the scope of the present disclosure.

The sensor part 240 may include a gyro sensor 241 or an acceleration sensor 243. The gyro sensor 241 may sense information on the movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor that senses a distance with respect to the display part 180 of the display device 100.

The output part 250 may output image or voice signals in response to the operation of the user input part 230, or may output image or voice signals corresponding to signals transmitted from the display device 100. A user may recognize whether the user input part 230 is operated or the display device 100 is controlled through the output part 250.

For example, the output part 250 may include an LED module 251 for flashing, a vibration module 253 for generating vibration, a sound output module 255 for outputting sound, or a display module 257 for outputting an image, if the user input part 230 is manipulated or signals are transmitted/received to/from the display device 100 through the wireless communication part 220.

Additionally, the power supply part 260 supplies power to the remote control device 200 and if the remote control device 200 does not move for a predetermined time, stops the power supply, so that power waste may be reduced. The power supply part 260 may resume the supply of power if a predetermined key provided at the remote control device 200 is operated.

The storage part 270 may store various kinds of programs and application data required to control or operate the remote control device 200. If the remote control device 200 transmits/receives signals wirelessly through the display device 100 and the RF module 221, the remote control device 200 and the display device 100 transmits/receives signals through a predetermined frequency band.

The control part 280 of the remote control device 200 may store, in the storage part 270, information on a frequency band for transmitting/receiving signals to/from the display device 100 paired with the remote control device 200 and refer to it.

The control part 280 controls general matters relating to the control of the remote control device 200. The control part 280 may transmit a signal corresponding to a predetermined key operation of the user input part 230 or a signal corresponding to the movement of the remote control device 200 sensed by the sensor part 240 to the display device 100 through the wireless communication part 220.

In addition, the sound acquisition part 290 of the remote control device 200 may acquire voice.

The sound acquisition part 290 may include at least one microphone and acquire voice through the microphone.

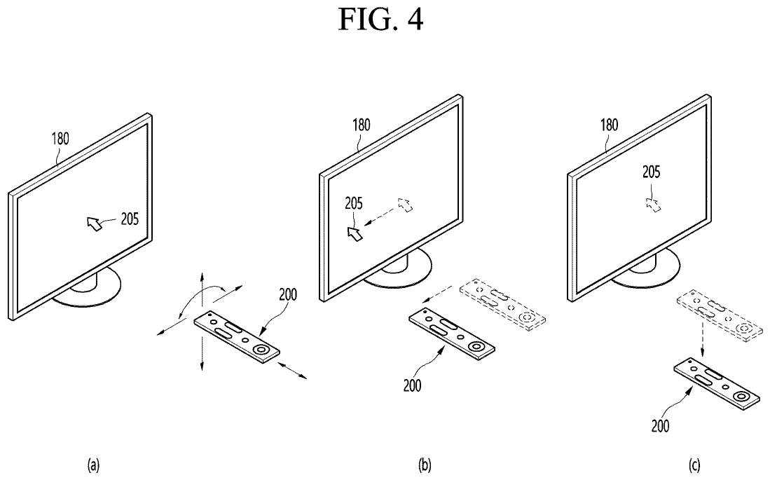

Next, FIG. 4 is described.

FIG. 4 is a view illustrating an example of utilizing a remote control device according to an embodiment of the present disclosure.

FIG. 4(a) illustrates that a pointer 205 corresponding to the remote control device 200 is displayed on the display part 180.

A user may move or rotate the remote control device 200 vertically or horizontally. The pointer 205 displayed on the display part 180 of the display device 100 corresponds to a movement of the remote control device 200. Since the corresponding pointer 205 is moved and displayed according to a movement on a 3D space as show in the drawing, the remote control device 200 may be referred to as a spatial remote control device.

FIG. 4(b) illustrates that if a user moves the remote control device 200, the pointer 205 displayed on the display part 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display part 180. Thus, a selected region in the display part 180 corresponding to the pointer 205 may be zoomed in and displayed in an enlarged size.

On the other hand, if a user moves the remote control device 200 close to the display part 180, a selection area in the display part 180 corresponding to the pointer 205 may be zoomed out and displayed in a reduced size.

On the other hand, if the remote control device 200 is moved away from the display part 180, a selection area may be zoomed out and if the remote control device 200 is moved closer to the display part 180, a selection area may be zoomed in.

Additionally, if a specific button in the remote control device 200 is pressed, recognition of a vertical or horizontal movement may be excluded. In other words, if the remote control device 200 is moved away from or closer to the display part 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display part 180 in response to an operation of the remote control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display part 180 and also may be displayed in correspondence to a plurality of points such as a line and a surface.

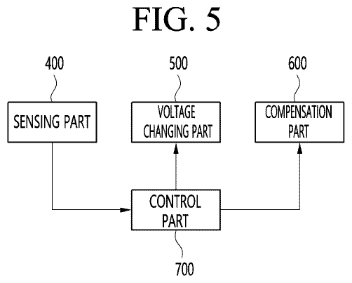

FIG. 5 is a block diagram illustrating a display device for reducing power consumption according to one embodiment of the present disclosure.

As illustrated in FIG. 5, the present disclosure may include a sensing part 400 that senses an output current supplied to a display module, a voltage changing part 500 that changes an output voltage supplied to the display module, a compensation part 600 that compensates for a loss of the sensing part 400 due to a change in the output voltage, and a control part 700 that controls the voltage changing part 500 and the compensation part 600.

Here, the sensing part 400 is placed at the output terminal of the power supply part that supplies power to the display module, and can sense the output current of the output voltage output from the power supply part to the display module.

For example, the sensing part 400 may include a current sensing resistor placed between the output terminal of the power supply part and the input terminal of the display panel, but this is only an example and is not limited thereto.

Next, the voltage changing part 500 may include a feedback circuit switch that switches according to a control signal of the control part 700, and a voltage changing resistor that has one side connected to the feedback circuit switch and changes an output voltage supplied to the display module according to a switching signal of the feedback circuit switch.

Next, the compensation part 600 may include an output switch that switches according to a control signal of the control part 700, and a path changing switch that is connected to the output switch and changes the output voltage path to delay the output current sensing of the sensing part 400 in response to the switching signal of the output switch.

In addition, the control part 700 determines whether to change the output voltage supplied to the display module based on the output current value sensed from the sensing part 400, controls the voltage changing part 500 to change the output voltage if it determines to change the output voltage, counts the number of times the output voltage is controlled to be changed, and controls the compensation part 600 to delay the sensing of the output current based on the counted number of times the change is controlled to compensate for the loss of the sensing part 400.

Here, when determining whether to change the output voltage, the control part 700 calculates the voltage value applied to the sensing part 400 based on the output current value sensed from the sensing part 400, and compares the calculated voltage value with a preset reference value to determine whether to change the output voltage.

For example, when calculating the voltage value applied to the sensing part 400, the control part 700 can calculate the voltage value applied to the sensing part 400 using a formula consisting of V_resistor=I_out×R_resistor (where V_resistor is the voltage value applied to the sensing part, I_out is the sensed output current value, and R_resistor is the resistance value of the sensing part).

In addition, the control part 700, when comparing the calculated voltage value with a preset reference value, can determine an output voltage change to provide a first output voltage if the calculated voltage value is equal to or greater than the reference value, and to provide a second output voltage that is lower than the first output voltage if the calculated voltage value is lower than the reference value.

Here, the control part 700 can reset the counted number of times the change is controlled if the calculated voltage value is less than the reference value and determine an output voltage change to reduce the first output voltage to the second output voltage.

Next, the control part 700, when controlling the voltage changing part 500, can control the voltage changing part 500 to provide the first output voltage if the voltage value applied to the sensing part 400 is equal to or greater than the reference value.

Here, the control part 700, when controlling the voltage changing part 500, can reset the counted number of times the change is controlled if the voltage value applied to the sensing part 400 is less than a reference value and determine an output voltage change to provide a second output voltage that is lower than the first output voltage.

Next, the control part 700, when counting the number of times the output voltage is controlled to be changed, can count the number of times the output voltage is controlled to be changed by increasing the counter by one each time the voltage changing part 500 is controlled to provide a first output voltage at a high level.

In addition, the control part 700, when delaying the sensing of the output current, can check the current number of times of the counter, determine whether the current number of times of the counter is equal to or less than the preset maximum number of times, and control the compensation part 600 to delay the sensing of the output current if the current number of times of the counter is equal to or less than the preset maximum number of times.

Next, the control part 700, when delaying the sensing of the output current, can measure the sensing delay time of the output current, check whether the sensing delay time of the output current reaches the preset time, and, when the sensing delay time of the output current reaches the preset time, control the compensation part 600 to release the sensing delay of the output current.

In one embodiment, the control part 700 may include a screen mode analysis part that analyzes the current screen mode, and a power consumption control part that controls the voltage changing part 500 and the compensation part 600 in response to a request for a change in the output voltage of the screen mode analysis part.

Here, the screen mode analysis part obtains mode information on the current screen mode of the display module, analyzes whether the current screen mode is a mode requiring a change in output voltage based on the obtained mode information, and if the current screen mode is a mode requiring a change in output voltage, can request a change in output voltage to the power consumption control part.

The screen mode analysis part can analyze the current screen mode as a mode requiring a change in output voltage if the ratio of bright images is equal to or greater than the preset ratio.

For example, the screen mode analysis part can analyze that the current screen mode is a mode requiring a change in output voltage when the current screen mode is a clear image mode.

In another embodiment, the control part 700 may include a screen mode setting part that sets a screen mode based on a user setting input, and a power consumption control part that controls a voltage changing part 500 and a compensation part 600 in response to a request for changing an output voltage of the screen mode setting part.

Here, the screen mode setting part, when receiving a user setting input, can change the current screen mode of the display module to a user-set screen mode corresponding to the user setting input, analyze whether the changed user-set screen mode is a mode requiring a change in output voltage, and if the user-set screen mode is a mode requiring a change in output voltage, can request a change in output voltage to the power consumption control part.

The screen mode setting part can analyze the user-set screen mode as a mode requiring a change in output voltage if the ratio of the bright image is equal to or greater than the preset ratio.

For example, the screen mode setting part can analyze that if the user-set screen mode is a clear image mode, the user-set screen mode is a mode requiring a change in output voltage.

As another embodiment, the control part 700 may include a power consumption analysis part that analyzes power consumption corresponding to the screen mode history of the display module, and a power consumption control part that controls the voltage changing part 500 and the compensation part 600 in response to a request for a change in the output voltage of the power consumption analysis part.

Here, the power consumption analysis part can obtain screen mode history information of the display module, analyze power consumption for a certain period of time from the present to the past based on the screen mode history information, and if the analyzed total power consumption is equal to or greater than a preset reference power consumption, request a change in output voltage to the power consumption control part.

In this way, the present disclosure can reduce power consumption of a video screen regardless of the image mode by sensing the output current of a voltage output terminal to increase or decrease the output voltage, thereby increasing the output voltage to provide a bright screen when the output current is large and decreasing the output voltage to provide a dark screen when the output current is small.

In addition, the present disclosure can minimize current loss in a circuit that senses output current by delaying sensing of the output current by counting the number of times the output voltage is controlled to be changed.

In other words, the present disclosure can reduce the power consumption of a display device not only by reducing power consumption in a specific image mode such as an eco mode, but also by reducing voltage according to the current of a video screen regardless of all image modes.

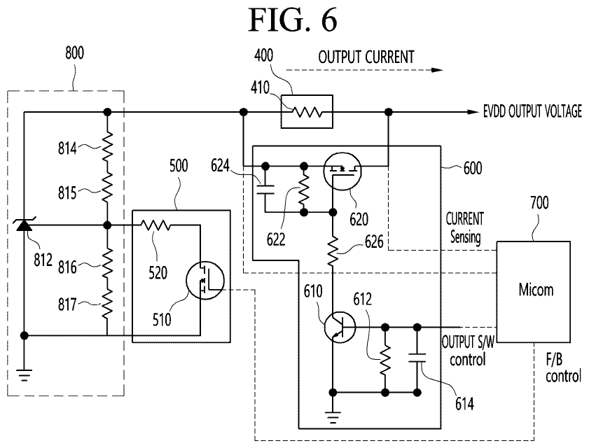

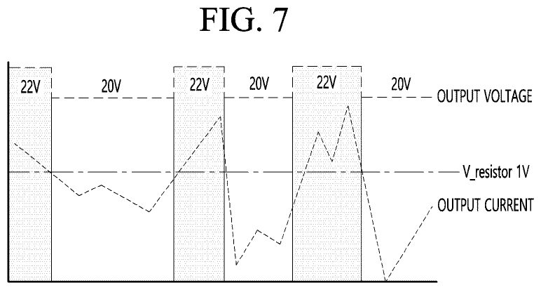

FIG. 6 is a circuit diagram for explaining a process for reducing power consumption of a display device according to an embodiment of the present disclosure, and FIG. 7 is a waveform diagram for explaining an output current sensing process of a display device according to an embodiment of the present disclosure.

As illustrated in FIGS. 6 and 7, the present disclosure may include a sensing part 400 that senses an output current supplied to a display module, a voltage changing part 500 that changes an output voltage supplied to the display module, a compensation part 600 that compensates for a loss of the sensing part 400 due to a change in the output voltage, and a control part 700 that controls the voltage changing part 500 and the compensation part 600.

Here, the sensing part 400 is placed at the output terminal of the power supply part that supplies power to the display module, and can sense the output current of the output voltage output from the power supply part to the display module.

For example, the sensing part 400 may include a current sensing resistor 410 placed between the output terminal of the power supply part and the input terminal of the display panel.

The current sensing resistor 410 may have one end connected to the compensation part 600 and the other end connected to the compensation part 600 and the control part 700.

Next, the voltage changing part 500 may include a feedback circuit switch 510 that switches according to a control signal of the control part 700, and a voltage changing resistor 520 that has one side connected to the feedback circuit switch 510 and changes an output voltage supplied to the display module according to a switching signal of the feedback circuit switch 510.

Here, the feedback circuit switch 510 may include a transistor having three connecting terminals.

At this time, the first connection terminal among the three connection terminals is connected to the control part 700, the second connection terminal is connected to one end of the voltage changing resistor 520, and the third connection terminal can be connected to ground.

In addition, the voltage changing resistor 520 may have one end connected to the feedback circuit switch 510 and the other end connected to the constant voltage circuit 800 of the power supply part.

For example, the constant voltage circuit 800 may include a Zener diode 812 having a first connection terminal connected to a sensing part 400, a second connection terminal connected to ground, and a third connection terminal connected to a voltage changing resistor 520.

Additionally, the constant voltage circuit 800 may include a plurality of resistors connected in parallel with the Zener diode 812.

Here, the plurality of resistors may include first to fourth resistors 814, 815, 816, 817 that are connected in series sequentially with each other.

For example, the first resistor 814 may have one end connected to a connection line between the first terminal of the Zener diode 812 and the sensing part 400 and the other end connected to the second resistor 815.

In addition, the second resistor 815 may have one end connected to the first resistor 814 and the other end connected to a connection line between the third connection terminal of the Zener diode 812 and the voltage changing resistor 520 of the voltage changing part 500.

Next, the third resistor 816 may have one end connected to a connection line between the second resistor 815, the third connection terminal of the Zener diode 812, and the voltage changing resistor 520 of the voltage changing part 500, and the other end connected to the fourth resistor 817.

Next, the fourth resistor 817 may have one end connected to the third resistor 816 and the other end connected to the connection line between the second connection terminal of the Zener diode 812 and the feedback circuit switch 510 of the voltage changing part 500.

Next, the compensation part 600 may include an output switch 610 that switches according to a control signal of the control part 700, and a path changing switch 620 that is connected to the output switch 610 and changes the output voltage path to delay the output current sensing of the sensing part 400 in response to the switching signal of the output switch 610.

Here, the path changing switch 620 may have a first connection terminal connected to an input terminal of the sensing part 400, a second connection terminal connected to an output switch 610, and a third connection terminal connected to an output terminal of the sensing part 400.

In addition, the output switch 610 may have a first connection terminal connected to a second connection terminal of a path changing switch 620, a second connection terminal connected to a control part 700, and a third connection terminal connected to ground.

In addition, the compensation part 600 may include a first capacitor 624 and a first resistor 622 that are connected in parallel to each other in a connection line between a first connection terminal of the path changing switch 620 and an input terminal of the sensing part 400, a second capacitor 614 and a second resistor 612 that are connected in parallel to each other in a connection line between a second connection terminal of the output switch 610 and the control part 700, and a third resistor 626 that is connected between the second connection terminal of the path changing switch 620 and the first connection terminal of the output switch 610.

Additionally, the control part 700 can determine whether to change the output voltage supplied to the display module based on the output current value sensed from the sensing part 400.

Here, the control part 700 can calculate the voltage value applied to the sensing part 400 based on the output current value sensed from the sensing part 400, and compare the calculated voltage value with a preset reference value to determine a change in the output voltage.

For example, the control part 700 can calculate the voltage value applied to the sensing part 400 using a formula consisting of V_resistor=I_out×R_resistor (where V_resistor is the voltage value applied to the sensing part, I_out is the sensed output current value, and R_resistor is the resistance value of the sensing part).

The control part 700, when comparing the calculated voltage value with a preset reference value, can determine an output voltage change to provide a first output voltage if the calculated voltage value is equal to or greater than the reference value, and to provide a second output voltage that is lower than the first output voltage when the calculated voltage value is lower than the reference value.

For example, as illustrated in FIG. 7, when the preset reference value is V_resistor 1V, if the voltage value applied to the sensing part is 1V or greater, a first output voltage of 22V can be provided, and if the voltage value applied to the sensing part is less than 1V, a second output voltage of 20V, which is lower than the first output voltage, can be provided.

Next, the control part 700 can control the voltage changing part 500 to provide the first output voltage if the voltage value applied to the sensing part 400 is equal to or greater than the reference value.

Here, the control part 700 can provide a first output voltage at a higher level than the second output voltage by switching the feedback circuit switch 510 of the voltage changing part 500.

In other words, the control part 700 can sense the output current whose current level increases due to a bright image and change the output voltage by switching the feedback circuit switch 510 of the voltage changing part 500 so that the voltage level increases accordingly.

Next, the control part 700 can control the voltage changing part 500 to provide a second output voltage that is lower than the first output voltage if the voltage value applied to the sensing part 400 is lower than the reference value.

Here, the control part 700 can provide a first output voltage at a lower level than the second output voltage by switching the feedback circuit switch 510 of the voltage changing part 500.

In other words, the control part 700 can sense the output current whose current level decreases due to a dark image and change the output voltage by switching the feedback circuit switch 510 of the voltage changing part 500 so that the voltage level decreases accordingly.

In addition, the control part 700 can count the number of times the output voltage is controlled to be changed and delay the sensing of the output current based on the counted number of times the change is controlled to compensate for the power loss of the sensing part 400.

In other words, since power loss may occur due to heat generation of the current sensing resistor 410 when a high current level corresponding to a bright image is applied to the current sensing resistor 410, the control part 700 can reduce the power loss of the current sensing resistor 410 by controlling the compensation circuit of the compensation part 600 so that a high current level is not applied to the current sensing resistor 410 for a certain period of time.

The control part 700 can count the number of times the output voltage is controlled to be changed by increasing the counter by one each time the voltage changing part 500 is controlled to provide a first output voltage of a high level.

In addition, when delaying the sensing of the output current, the control part 700 can check the current number of times of the counter, determine whether the current count of the counter is equal to or less than the preset maximum count, and control the output switch 610 of the compensation part 600 to delay the sensing of the output current if the current count of the counter is equal to or less than the preset maximum count.

Next, the control part 700 can measure the sensing delay time of the output current when delaying the sensing of the output current, check whether the sensing delay time of the output current reaches the preset time, and control the output switch 610 of the compensation part 600 to release the sensing delay of the output current when the sensing delay time of the output current reaches the preset time.

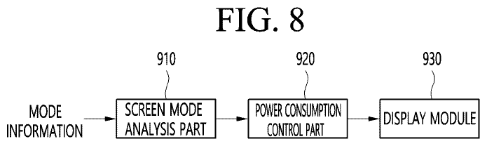

FIGS. 8 to 10 are block diagrams for explaining a determination of a change in output voltage of a display device according to an embodiment of the present disclosure.

As illustrated in FIG. 8, the present disclosure may include a screen mode analysis part 940 that analyzes a current screen mode, and a power consumption control part 920 that controls a voltage variable circuit in response to a request for changing an output voltage of the screen mode analysis part 910.

Here, the screen mode analysis part 910 can obtain mode information on the current screen mode of the display module 930, analyze whether the current screen mode is a mode requiring a change in output voltage based on the obtained mode information, and if the current screen mode is a mode requiring a change in output voltage, request a change in output voltage to the power consumption control part 920.

For example, the screen mode analysis part 910 can analyze the current screen mode as a mode requiring a change in output voltage if the ratio of bright images is greater than the preset ratio.

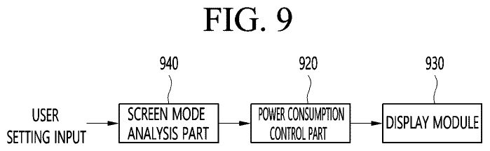

In some cases, as illustrated in FIG. 9, the present disclosure may include a screen mode setting part 940 that sets a screen mode based on a user setting input, and a power consumption control part 920 that controls a voltage variable circuit in response to a request for changing an output voltage of the screen mode setting part 940.

Here, the screen mode setting part 940 changes the current screen mode of the display module 930 to a user-set screen mode corresponding to the user-set input when receiving a user-set input, analyzes whether the changed user-set screen mode is a mode requiring a change in output voltage, and if the user-set screen mode is a mode requiring a change in output voltage, requests a change in output voltage to the power consumption control part 920.

For example, the screen mode setting part 940 can analyze the user-set screen mode as a mode requiring a change in output voltage if the ratio of bright images is equal to or greater than the preset ratio.

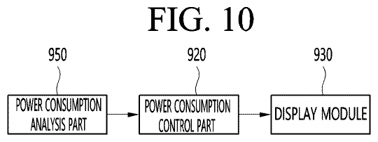

In another case, as illustrated in FIG. 10, the present disclosure may include a power consumption analysis part 950 that analyzes power consumption corresponding to a screen mode history of a display module 930, and a power consumption control part 920 that controls a voltage variable circuit corresponding to a request for changing an output voltage of the power consumption analysis part 950.

Here, the power consumption analysis part 950 obtains screen mode history information of the display module 930, analyzes power consumption for a certain period of time from the present to the past based on the screen mode history information, and if the analyzed total power consumption is equal to or greater than a preset reference power consumption, request a change in output voltage to the power consumption control part 920.

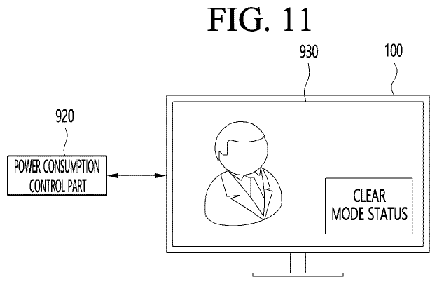

FIGS. 11 to 13 are diagrams for explaining an output voltage change control process of a display device according to an embodiment of the present disclosure.

As illustrated in FIG. 11, the present disclosure can obtain mode information on the current screen mode of the display module 930 of the display device 100.

Additionally, the present disclosure can analyze whether the current screen mode is a mode requiring an output voltage change based on the obtained mode information.

Here, the present disclosure can be analyzed as a mode requiring an output voltage change if the current screen mode has a ratio of bright images equal to or greater than a preset ratio.

As an example, the present disclosure can analyze that if the current screen mode is a clear image mode, it is a mode requiring a change in output voltage.

Next, the present disclosure can perform an output voltage change by sensing an output current corresponding to the brightness of the image through a power consumption control part 920 if the current screen mode is a mode requiring an output voltage change.

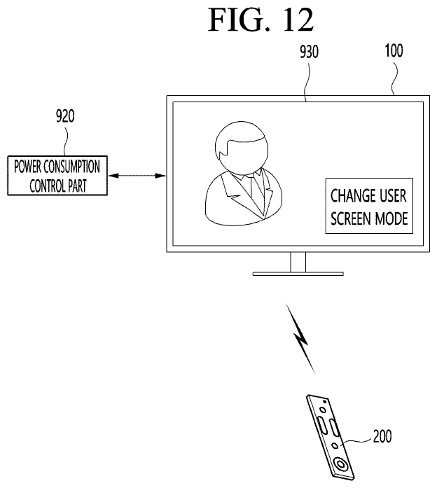

In some cases, as illustrated in FIG. 12, the present disclosure may change the current screen mode of the display module 930 to a user-set screen mode corresponding to the user-set input when receiving a user-set input via a remote control device 200.

Additionally, the present disclosure can analyze whether the changed user-set screen mode is a mode requiring a change in output voltage.

Here, the present disclosure can be analyzed as a mode requiring an output voltage change if the current screen mode has a ratio of bright images equal to or greater than a preset ratio.

As an example, the present disclosure can analyze that if the current screen mode is a clear image mode, it is a mode requiring a change in output voltage.

Next, the present disclosure can perform an output voltage change by sensing an output current corresponding to the brightness of the image through a power consumption control part 920 if the current screen mode is a mode requiring an output voltage change.

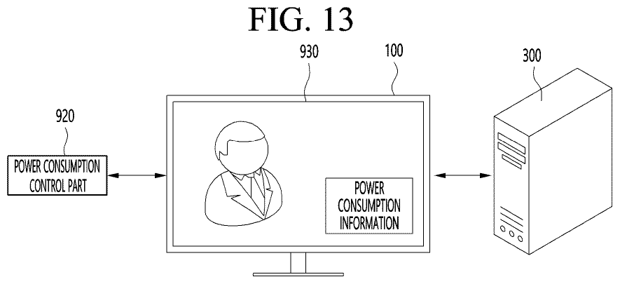

In another case, as illustrated in FIG. 13, the present disclosure can analyze power consumption corresponding to the screen mode history of the display module 930.

Here, the present disclosure can obtain screen mode history information of the display module 930 from an external server 300 or internal memory.

In addition, the present disclosure can analyze power consumption for a certain period of time from the present to the past based on screen mode history information.

Next, the present disclosure can sense the output current corresponding to the brightness of the image through the power consumption control part 920 and change the output voltage if the analyzed total power consumption is equal to or greater than a preset reference power consumption.

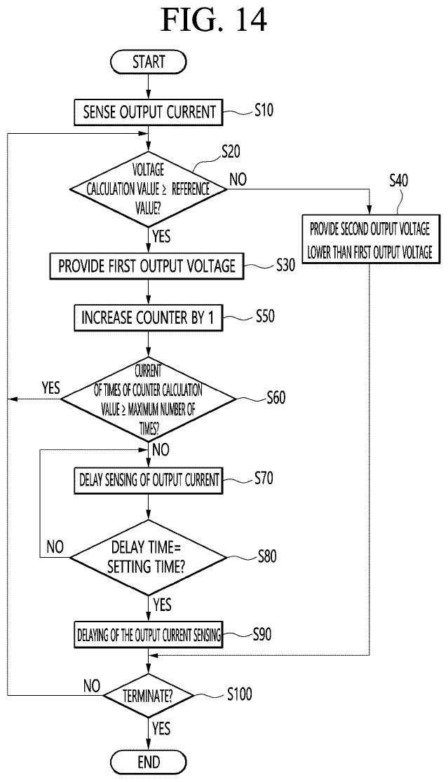

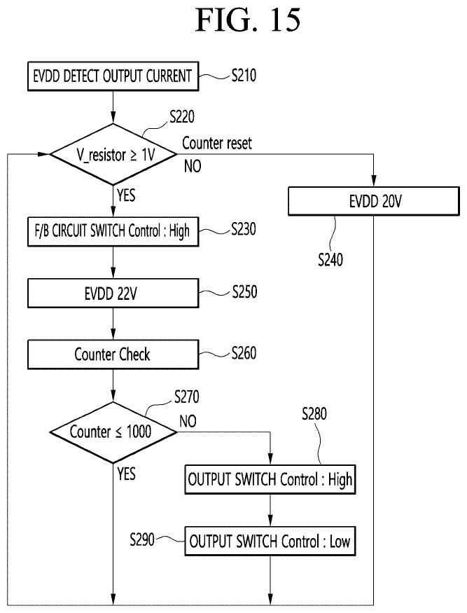

FIGS. 14 and 15 are flowcharts for explaining a process for reducing power consumption of a display device according to an embodiment of the present disclosure.

As illustrated in FIG. 14, the present disclosure can sense the output current of a voltage output terminal supplied to a display module (S10).

In addition, the present disclosure can calculate a voltage value applied to a sensing part based on the sensed output current, and compare the calculated voltage value with a preset reference value to determine a change in the output voltage (S20).

Here, the present disclosure can calculate the voltage value applied to the sensing part by a formula consisting of V_resistor=I_out×R_resistor (wherein, V_resistor is the voltage value applied to the sensing part, I_out is the sensed output current value, and R_resistor is the resistance value of the sensing part).

Next, the present disclosure changes the output voltage to provide a first output voltage if the voltage value applied to the sensing part is equal to or greater than a reference value (S30), and if the voltage value applied to the sensing part is less than the reference value, the counted number of times the change is controlled is reset and the output voltage can be changed to provide a second output voltage lower than the first output voltage (S40).

Next, the present disclosure can count the number of times the output voltage is controlled to be changed by incrementing the counter by one when the output voltage is changed to provide the first output voltage (S50).

In addition, the present disclosure can check the current number of times of the counter and determine whether the current number of times of the counter is equal to or less than a preset maximum count (S60).

Next, the present disclosure can delay sensing of the output current if the current count of the counter is equal to or less than a preset maximum number of times (S70).

Next, the present disclosure can measure the sensing delay time of the output current and check whether the sensing delay time of the output current reaches a preset time (S80).

In addition, the present disclosure can release the sensing delay of the output current when the sensing delay time of the output current reaches a preset time (S90).

Next, the present disclosure checks whether there is a request to terminate a voltage variable operation (S100), and if there is a request to terminate a voltage variable operation, all operations can be terminated.

As illustrated in FIG. 15, based on the setting conditions in which the reference value compared with the voltage value applied to the sensing part is set to 1 V, the maximum number of times corresponding to the number of times the output voltage is controlled to be changed is set to 1000, the sensing delay time of the output current is set to 10 seconds, the first output voltage corresponding to the high-potential power supply (EVDD) is set to 22 V, and the second output voltage corresponding to the high-potential power supply (EVDD) is set to 20 V, the power consumption reduction process is explained as follows.

First, the present disclosure can detect an output current corresponding to a high-potential power supply (EVDD) (S210).

Next, the present disclosure calculates a voltage value across both ends of a current sensing resistor based on an output current, and determines whether the calculated voltage value is equal to or greater than a reference value of 1 V (S220).

In addition, the present disclosure can apply a control signal at a high level to the feedback circuit switch if the calculated voltage value is equal to or greater than the reference value 1 V (S230).

Next, the present disclosure can supply a first output voltage of 22 V corresponding to a high-potential power supply (EVDD) due to a switching operation of a feedback circuit switch (S250).

Next, the present disclosure can count the number of times the first output voltage of 22 V is supplied when the first output voltage of 22 V is supplied (S260).

In addition, the present disclosure can check whether the number of times the first output voltage of 22 V is supplied is less than 1000 times (S270).

Next, the present disclosure can delay the sensing of the output current by changing the path so that the first output voltage of 22 V is not applied to the current sensing resistor by applying a control signal at a high level to the output switch (S280) when the number of times the first output voltage of 22 V is supplied is 1000 or more.

Next, the present disclosure can measure the sensing delay time of the output current and check whether the sensing delay time of the output current reaches a preset time of 10 seconds.

In addition, the present disclosure can release the sensing delay of the output current by changing the path so that the first output voltage of 22 V is re-applied to the current sensing resistor by applying a control signal at a low level to the output switch (S290) when the sensing delay time of the output current reaches the preset time of 10 seconds.

Meanwhile, the present disclosure can reset the number of times the first output voltage of 22 V is supplied if the calculated voltage value is less than the reference value 1 V and provide a second output voltage of 20 V that is lower than the first output voltage (S240).

In this way, the present disclosure can reduce power consumption of a video screen regardless of the image mode by sensing the output current of a voltage output terminal to increase or decrease the output voltage, thereby increasing the output voltage to provide a bright screen when the output current is large and decreasing the output voltage to provide a dark screen when the output current is small.

In addition, the present disclosure can minimize current loss in a circuit that senses output current by delaying sensing of the output current by counting the number of times the output voltage is controlled to be changed.

In other words, the present disclosure can reduce the power consumption of a display device not only by reducing power consumption in a specific image mode such as an eco mode, but also by reducing voltage according to the current of a video screen regardless of all image modes.

The above-described present disclosure can be implemented as a computer-readable code on a medium in which a program is recorded. The computer-readable medium includes all kinds of recording devices in which data that can be read by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. In addition, the computer may include a processor (180) of an artificial intelligence device.

### INDUSTRIAL APPLICABILITY

According to the display device according to the present disclosure, by sensing the output current of a voltage output terminal and increasing or decreasing the output voltage, the output voltage is increased to provide a bright screen when the output current is large, and the output voltage is decreased to provide a dark screen when the output current is small, thereby reducing the power consumption of the video screen regardless of the image mode, and therefore, the industrial applicability is remarkable.

1. A display device comprising:
a sensing part sensing an output current supplied to a display module;
a voltage changing part changing an output voltage supplied to the display module;
a compensation part compensating for a loss of the sensing part due to a change in the output voltage; and,
a control part controlling the voltage changing part and the compensation part,
wherein the control part determines whether to change the output voltage supplied to the display module based on the output current value sensed by the sensing part, and controls the voltage changing part to change the output voltage if the change in the output voltage is determined, counts the number of times the output voltage is controlled to be change, and controls the compensation part to compensate for the loss of the sensing part by delaying the sensing of the output current based on the counted number of times the change is controlled.

2. The display device of claim 1,
wherein the sensing part is arranged at an output terminal of a power supply part that supplies power to the display module and senses an output current of an output voltage output from the power supply part to the display module.

3. The display device of claim 2,
wherein the sensing part includes a current sensing resistor arranged between the output terminal of the power supply part and the input terminal of the display panel.

4. The display device of claim 1,
wherein the voltage changing part includes:
a feedback circuit switch switching according to a control signal of the control part; and
a voltage changing resistor connected to one side of the feedback circuit switch and changing an output voltage supplied to the display module according to a switching signal of the feedback circuit switch.

5. The display device of claim 1,
wherein the compensation part includes:
an output switch switching according to a control signal of the control part; and,
a path changing switch connected to the output switch and changing the output voltage path to delay the output current sensing of the sensing part in response to the switching signal of the output switch.

6. The display device of claim 1,
wherein control part,
when determining whether to change the output voltage, calculates a voltage value applied to the sensing part based on the output current value sensed from the sensing part, and compares the calculated voltage value with a preset reference value to determine a change in the output voltage.

7. The display device of claim 6,
Wherein the control part,
when calculating the voltage value applied to the sensing part, calculates the voltage value applied to the sensing part by a formula consisting of V_resistor=I_out×R_resistor (wherein, V_resistor is the voltage value applied to the sensing part, I_out is the sensed output current value, and R_resistor is the resistance value of the sensing part).

8. The display device of claim 6,
Wherein the control part,
when comparing the calculated voltage value with a preset reference value, determines to change the output voltage so that, if the calculated voltage value is equal to or greater than the reference value, a first output voltage is provided, and if the calculated voltage value is lower than the reference value, a second output voltage is provided that is lower than the first output voltage.

9. The display device of claim 8,
wherein the control part,
if the calculated voltage value is less than the reference value, resets the counted number of times the change is controlled and determines the output voltage change to decrease the first output voltage to the second output voltage.

10. The display device of claim 1,
wherein the control part,
when controlling the voltage changing part, controls the voltage changing part to provide a first output voltage if the voltage value applied to the sensing part is equal to or greater than a reference value.

11. The display device of claim 10,
wherein the control part,
when controlling the voltage changing part, if the voltage value applied to the sensing part is less than a reference value, determines the output voltage change to resets the counted number of times the change is controlled and to provide a second output voltage lower than the first output voltage.

12. The display device of claim 1,
wherein the control part,
when counting the number of times the output voltage is controlled to be changed, increases the counter by one each time the voltage changing part is controlled to provide the first output voltage at a high level, thereby counting the number of times the output voltage is controlled to be changed.

13. The display device of claim 1,
Wherein the control part,
when delaying the sensing of the output current, checks the current number of times of the counter, determines whether the current number of times of the counter is equal to or less than the preset maximum number of times, and controls the compensation part to delay the sensing of the output current if the current number of times of the counter is equal to or less than the preset maximum number of times.

14. The display device of claim 1,
wherein the control part,
when delaying the sensing of the output current, measures the sensing delay time of the output current, checks whether the sensing delay time of the output current reaches a preset time, and controls the compensation part to release the sensing delay of the output current when the sensing delay time of the output current reaches the preset time.

15. A method for reducing power consumption of a display device including a display module, comprising:
sensing an output current of a voltage output terminal supplied to the display module;
changing an output voltage supplied to the display module based on the output current;
counting the number of times the output voltage is controlled to be changed;
delaying the sensing of the output current based on the counted number of times the change is controlled; and
releasing the sensing delay of the output current when the sensing delay time of the output current reaches a set time.
